(19) United States
(12) Patent Application Publication
(10) Pub. No.: US 2026/0135808 A1
(43) Pub. Date: May 14, 2026

(54) TRANSPORT NETWORK ROUTING

(71) Applicant: Telefonaktiebolaget LM Ericsson (publ), Stockholm (SE)

(72) Inventors: Marzio PULERI, Pisa (IT); Paola IOVANNA, Pisa (IT); Giulio BOTTARI, Pisa (IT); Alberto ROSSI, Pisa (IT)

(21) Appl. No.: 18/706,172

(22) PCT Filed: Nov. 5, 2021
(86) PCT No.: PCT/EP2021/080831

§ 371 Date: Apr. 30, 2024

(51) Int. Cl. H04L 47/125; H04L 45/00; H04L 47/10; H04L 47/83

(52) U.S. Cl. CPC H04L 47/125; H04L 45/22; H04L 47/18; H04L 47/83

(57) ABSTRACT

A method performed by a network dynamics module for a communication network including a transport network is provided. The method includes determining whether a connection per transport tunnel can be established to support the service based on an assigned initial bandwidth per transport tunnel. The method further includes, when the connection is established, calculating a new bandwidth value per connection per transport tunnel. The method further includes receiving a determined bandwidth for an estimated traffic flow for a future time period per active transport tunnel. The method further includes selecting a routing path according to a learned policy of an artificial intelligence, AI, model that selects based on load balancing for the future time period in view of the bandwidth of the estimated traffic flow, the new bandwidth values, and a bandwidth value of an E2E slice.

### TECHNICAL FIELD

The present disclosure relates generally to methods for transport network routing when the transport network includes at least one transport slice, corresponding to an end-to-end (E2E) slice, comprising one or a plurality of transport tunnels, and related methods and apparatuses.

### BACKGROUND

Starting from fifth generation (5G) mobile network technology and evolving towards sixth generation (6G) technology, a large amount of application requirements are driving a rapid growth of network and service capacity, resulting in great complexity in the management of resources. For example, diverse combinations of infrastructure elements may need to be configured and tuned for efficient operation of heterogenous services having different end-to-end (E2E) quality of service (QoS) needs. As a service spans a geographical dimension, similarly a slice that supports the service includes transport resources, displaced on the same deployment area.

FIG. 1 is a schematic illustrating a communication network 100 that includes a service spanning a deployment area 103 served by two antennas. In the example of FIG. 1, an end-to-end (E2E) slice 101 on the deployment area 103 (also referred to herein as a “service area”) includes a radio slice 1, with a relevant QoS parameter (e.g., a 5G quality indicator (5Q1) for 5G), and a transport slice 1 with a relevant QoS parameter (e.g., like Peak Information Rate (PIR), Committed Information Rate (CIR), Committed Burst Size (CBS), etc.). The transport slice 1 includes a tunnel, which may be deployed according to a specific transport technology (e.g., a virtual local area network (VLAN)).

### SUMMARY

There currently exist certain challenges, however, with some approaches for assigning a bandwidth to an E2E slice for a service to satisfy a QoS parameter for the service. Existing approaches may provide overprovisioning by assigning a peak value of the bandwidth to each transport tunnel or transport slice in the E2E slice. Practically, such an approach means assigning double the bandwidth to the E2E slice.

Certain aspects of the disclosure and their embodiments may provide solutions to these or other challenges.

In various embodiments, a method is provided that is performed by a network dynamics module for a communication network comprising a transport network. The transport network includes at least one transport slice comprising a plurality of transport tunnels for a service on a service area defined by an E2E slice, and a QoS parameter per transport tunnel. The method includes determining whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The method further includes, when the connection is established, calculating a new bandwidth value per connection per transport tunnel based on statistics from measurements of traffic flow per transport tunnel and a corresponding QoS parameter for the transport tunnel. The method further includes receiving a determined bandwidth for an estimated traffic flow for a future time period per active transport tunnel in the plurality of transport tunnels. The determined bandwidth is calculated from measurements at a defined periodicity of traffic and the QoS parameter per active transport tunnel. The method further includes selecting a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice.

In other embodiments, a network dynamics module is provided for a communication network comprising a transport network including at least one transport slice comprising a plurality of transport tunnels for a service on a service area defined by an E2E slice, and a QoS, parameter per transport tunnel. The network dynamics module includes at least one processor; and at least one memory connected to the at least one processor and storing program code that is executed by the at least one processor to perform operations. The operations include determine whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The operations further include, when the connection is established, calculate a new bandwidth value per connection per transport tunnel based on statistics from measurements of traffic flow per transport tunnel and a corresponding QoS parameter for the transport tunnel. The operations further include receive a determined bandwidth for an estimated traffic flow for a future time period per active transport tunnel in the plurality of transport tunnels. The determined bandwidth is calculated from measurements at a defined periodicity of traffic and the QoS parameter per active transport tunnel. The operations further include select a routing path from a plurality of candidate routing paths according to a learned policy of an AI model that selects the routing path based on load balancing for the future time period in view of the bandwidth of the estimated traffic flow, the new bandwidth values, and the bandwidth value of the E2E slice.

In other embodiments, a network dynamics module is provided for a communication network comprising a transport network including at least one transport slice comprising a plurality of transport tunnels for a service on a service area defined by an E2E slice, and a QoS parameter per transport tunnel. The network dynamics module is adapted to perform operations. The operations include determine whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The operations further include, when the connection is established, calculate a new bandwidth value per connection per transport tunnel based on statistics from measurements of traffic flow per transport tunnel and a corresponding QoS parameter for the transport tunnel. The operations further include receive a determined bandwidth for an estimated traffic flow for a future time period per active transport tunnel in the plurality of transport tunnels. The determined bandwidth is calculated from measurements at a defined periodicity of traffic and the QoS parameter per active transport tunnel. The operations further include select a routing path from a plurality of candidate routing paths according to a learned policy of an AI model that selects the routing path based on load balancing for the future time period in view of the bandwidth of the estimated traffic flow, the new bandwidth values, and the bandwidth value of the E2E slice.

In other embodiments, a computer program comprising program code to be executed by processing circuitry of a network dynamics module is provided for a communication network comprising a transport network including at least one transport slice comprising a plurality of transport tunnels for a service on a service area defined by an E2E slice, and a QoS parameter per transport tunnel. Execution of the program code causes the network dynamics module to perform operations. The operations include determine whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The operations further include, when the connection is established, calculate a new bandwidth value per connection per transport tunnel based on statistics from measurements of traffic flow per transport tunnel and a corresponding QoS parameter for the transport tunnel. The operations further include receive a determined bandwidth for an estimated traffic flow for a future time period per active transport tunnel in the plurality of transport tunnels. The determined bandwidth is calculated from measurements at a defined periodicity of traffic and the QoS parameter per active transport tunnel. The operations further include select a routing path from a plurality of candidate routing paths according to a learned policy of an AI model that selects the routing path based on load balancing for the future time period in view of the bandwidth of the estimated traffic flow, the new bandwidth values, and the bandwidth value of the E2E slice.

In other embodiments, a computer program product comprising a non-transitory storage medium including program code to be executed by processing circuitry of a network dynamics module is provided for a communication network comprising a transport network including at least one transport slice comprising a plurality of transport tunnels for a service on a service area defined by an E2E slice, and a QoS parameter per transport tunnel. Execution of the program code causes the network dynamics module to perform operations. The operations include determine whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The operations further include, when the connection is established, calculate a new bandwidth value per connection per transport tunnel based on statistics from measurements of traffic flow per transport tunnel and a corresponding QoS parameter for the transport tunnel. The operations further include receive a determined bandwidth for an estimated traffic flow for a future time period per active transport tunnel in the plurality of transport tunnels. The determined bandwidth is calculated from measurements at a defined periodicity of traffic and the QoS parameter per active transport tunnel. The operations further include select a routing path from a plurality of candidate routing paths according to a learned policy of an AI model that selects the routing path based on load balancing for the future time period in view of the bandwidth of the estimated traffic flow, the new bandwidth values, and the bandwidth value of the E2E slice.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic illustrating a communication network that includes a service spanning a deployment area served by two antennas;

FIG. 2 is a schematic illustrating a high-level overview of a communication network in accordance with some embodiments of the present disclosure;

FIG. 3 is a schematic diagram illustrating an example communication network of some embodiments of the present disclosure;

FIG. 4 is a schematic diagram illustrating a communication network including a network dynamics module in accordance with some embodiments of the present disclosure;

FIG. 5 is a flowchart of operations for an allocation phase in accordance with some embodiments of the present disclosure;

FIG. 6 is a flowchart of operations during a runtime phase for calculating a new bandwidth value and traffic statistics in accordance with some embodiments of the present disclosure;

FIG. 7 is a flowchart of operations during a runtime phase for a learning workflow for network dynamics in accordance with some embodiments of the present disclosure;

FIG. 8 is a flowchart of operations during a runtime phase for a decision inferencing workflow for network dynamics in accordance with some embodiments of the present disclosure;

FIG. 9 is a block diagram illustrating a network dynamics module according to some embodiments of the present disclosure;

FIGS. 10 and 11 are flow charts illustrating operations of a network dynamics module according to some embodiments of the present disclosure; and

FIG. 12 is a block diagram of a virtualization environment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

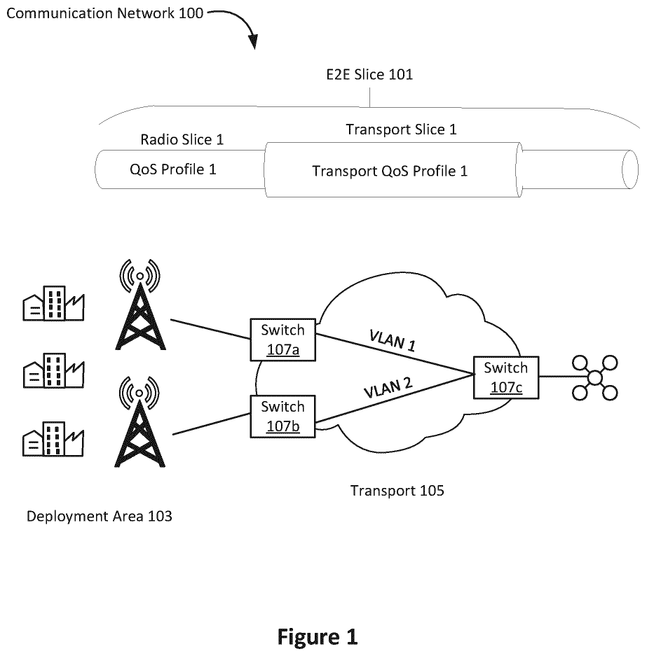

Referring to FIG. 1, as a service is deployed on deployment area 103 and on a time interval, more transport tunnels (e.g., VLAN1 and VLAN2 in FIG. 1) belong to the same transport slice 1 in association with the same service. Each tunnel can have particular values for a QoS parameter(s). For example, due to nomadic characteristics of a service, VLAN1 and VLAN2 in the time slot of interest, can have different PIR values. Thus, to improve or optimize resource usage, it may be desired that the assignment of QoS parameters is done according to the service distribution in space (e.g., in a geographic deployment region) and time.

Such circumstances pose new challenges for managing a transport slice that is composed of multiple transport tunnels.

A transport network for 5G should not introduce bottlenecks for radio performances. Thus, in some approaches, the transport network is dimensioned on a peak of expected radio traffic loads applying an “over-provisioning” approach.

A problem with this approach may be cost because the transport resources are not optimized for the dynamic nature of radio traffic. The client traffic, originated by a User Equipment (UE) often is dynamic and (at least partially) related to predictable situations or historical trends, such as, time of the day, weekdays versus weekend, and similar conditions influencing the radio traffic load.

The advent of new services, such as the vertical ones deployed on a service area such as a local area or on a larger geographical area, may pose new requirements and challenges to support the required mix of services and QoS while achieving an improved or best possible resource optimization.

The deployment area may be a street, a port, a campus, a city, etc., As a service changes in space and time over the area, it may be desirable that the corresponding assignment of the QoS parameters to the transport tunnels supporting a transport slice is done dynamically with appropriate mechanisms that are not available in existing approaches. For example, a total bandwidth value may be assigned on the transport slice that refers to a service area (e.g., a geographical area). A potential problem may exist as to how to partition such total bandwidth of the service in the service area in the corresponding transport tunnels (e.g., VLANs) of a transport slice. For example, if there are two transport tunnels or slices (e.g., two VLANs) corresponding to an E2E slice, a problem may exist as to how to map the bandwidth value of the E2E slice in the two transport VLANs. To guarantee the QoS, some approaches provide an overprovisioning by assigning to each transport tunnel (e.g., each VLAN), a peak value of the bandwidth. However, practically, this essentially means that double bandwidth may be assigned to the E2E slice. Thus, there is a need for partitioning the bandwidth value of the E2E slice in each transport tunnel (e.g., in each VLAN) according to actual traffic needs such that the sum of bandwidth in the transport tunnels (e.g., in two VLANs) is less than or equal to the amount of the E2E slice bandwidth.

Additionally, vertical operators may not be aware, in advance, of specified QoS parameters (e.g., PIR, CIR, etc.) to be assigned to a service(s). As such, there may also be a need to dynamically support current needs in the network and tune slices accordingly.

Some approaches include an artificial Intelligence (AI) approach to manage closed loop mechanisms based on traffic prediction and actions. Such AI-based approaches, however, may not consider traffic behavior originated by a mix of services with different QoS needs over a time and space dimensions (referred to herein as nomadic characteristic in a deployment area).

It also may be desirable to have a reduction of admitted network configurations where an AI process operates, which may help to reduce computational requirements.

Thus, there may be a need for an improved or optimized criteria aware transport technology. For example, if a transport network is packet based, load balancing may be a criteria that can be used in an AI-based approach to reduce a list of candidate routing paths. In another example, if a network is based on packet-optical technology, a criterion that may be considered is that it may be preferable to fully fill one optical channel at a time, rather than distributing traffic homogenously.

While example embodiments herein are discussed in the context of a packet transport network, the present disclosure is not so limited and may include other types of transport networks, e.g., packet-optical transport networks, etc.

Various embodiments of the present disclosure include AI processes that may improve or optimize, e.g. in the medium or long term, resource usage in a transport network that serves a radio network (e.g., 5G and beyond) including, without limitation, with reference to vertical services having certain E2E QoS needs. Services can be dispatched in a service area that could be local or geographical while the QoS can be tuned considering nomadic characteristic of the service in the service area. In some embodiments, metering points can measure traffic at packet nodes located at a border of the transport network which covers the deployment area of the service(s). The measured data can be integrated with a network indicator (e.g., an indicator showing a network status, such as the network is down, the network is active, etc.) and with information related to other circumstances (e.g., time of the day, events, etc.).

In some embodiments, the AI processes can use the measured data, network indicator, and/or other information to determine traffic trends and behaviors with time over the considered service area. As a consequence, insights on actual radio traffic conditions may be obtained which may not be observed and understood otherwise.

In some embodiments, an output of an AI process(es) can be used to manage the transport resources and to determine if: (1) Connection(s) can be established to support a service according to a needed or specified QoS parameter(s) (for ease of discussion only, this AI-based process is referred to herein as a Connections Admission Control (CAC) functionality or process). The CAC process can consider whether more connections need to be set to guarantee the service on a desired or required service area corresponding to the E2E slice; (2) The QoS parameter(s) (e.g., PIR, CIR, CBS, etc.) can be tuned according to the actual needs of traffic flows. As a consequence, overprovisioning for assigning the appropriate QoS parameters (e.g., PIR, CIR, CBS, etc.) on multiple traffic tunnels (e.g., VLANs, etc.) belonging to the same E2E slice may be avoided. In some embodiments, nomadic characteristic of the services are considered and actual QoS parameters are assigned to each transport tunnel (e.g., VLAN, etc.) belonging to the same E2E slice; (3) Traffic engineering actions on the transport network (e.g., re-routing, pre-emption, etc.) may be triggered to increase the amount of traffic that the radio network can support.

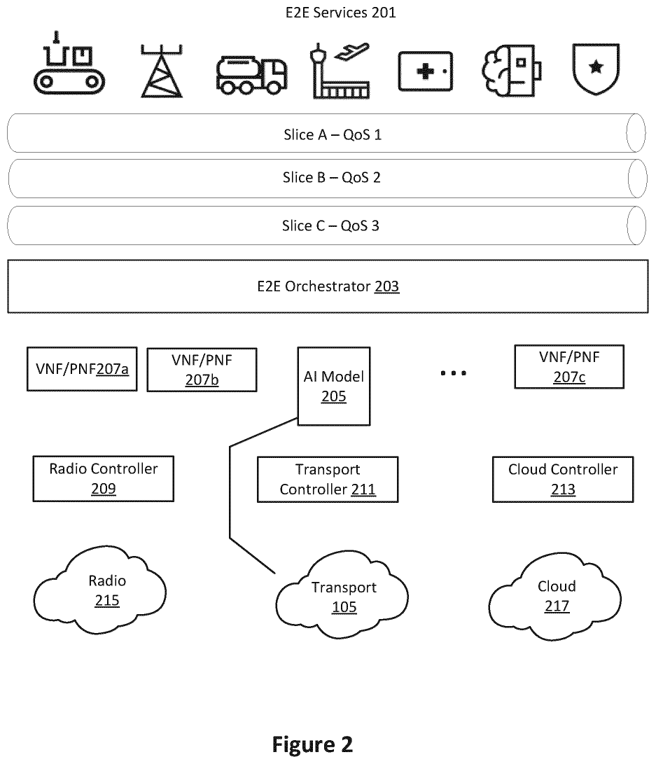

FIG. 2 is a schematic illustrating a high-level overview of a communication network in accordance with some embodiments of the present disclosure. In the example of FIG. 2, E2E orchestrator 203 can be, e.g., a network functions virtualization orchestrator (NFVO). An AI-based module 205 (also referred to herein as AI model 205) is included, and is discussed further herein. AI model 205 can be deployed in various ways including, without limitation, as a software component of a network dynamics module (e.g., E2E orchestrator 203 or as a building block embedded in or triggered by transport controller 211 (e.g., a software defined network (SDN)).

In some embodiments, the AI model can be used in the construction of an abstraction view of transport resources exposed to an orchestrator. “Abstraction” refers to a “compact” description of a resource (e.g., radio, transport, and/or cloud) exposed with corresponding service parameters. Abstraction can allow hiding of resource details (such as, e.g., quantity, vendors, location of the resource, physical details, real topology, etc.) and consideration of the transport from a start of the placement process. In some embodiments, the abstraction view can be tailored based on an identification, estimate, or definition of traffic trends.

In some embodiments, a method including a synergic combination of traffic trends analysis with flows behavior analysis using an AI model is provided. The method may enforce a closed loop, driven by real time insights of traffic traversing a transport network combined with other external conditions.

Various embodiments of the present disclosure may support nomadic characteristic of 5G and future 6G services (and beyond) where more transport connections (e.g., VLANs) belong to the same E2E slice(s) with dynamic variation in time and space of a transport QoS parameter(s).

In some embodiments, the transport network can serve a radio network, a fixed network or both.

As discussed further herein, in various embodiments, a network dynamics module performs the method. The network dynamics module includes at least one processor; an AI model; and at least one memory connected to the at least one processor and AI model and storing program code that is executed by the at least one processor and/or AI model to perform operations of the method. In some embodiments, the program code is written in a programming language, e.g., Python.

Certain embodiments may provide one or more of the following technical advantages. Resources of a transport network infrastructure may be used with more efficiency in a medium/long-term time period, which may reduce overprovisioning and resource reservation (e.g., reduction to a minimum possible level). Moreover, as a consequence, a cost of the transport network may be improved or optimized. Additionally, vertical service providers may dynamically request support for a new service based on preliminary QoS parameters. Later, the service provider(s) may update their QoS parameter(s) by “paying” a delta of resources instead of requiring an overprovisioned network, including where the overprovisioned network was dimensioned with a “peak-based” approach since the beginning.

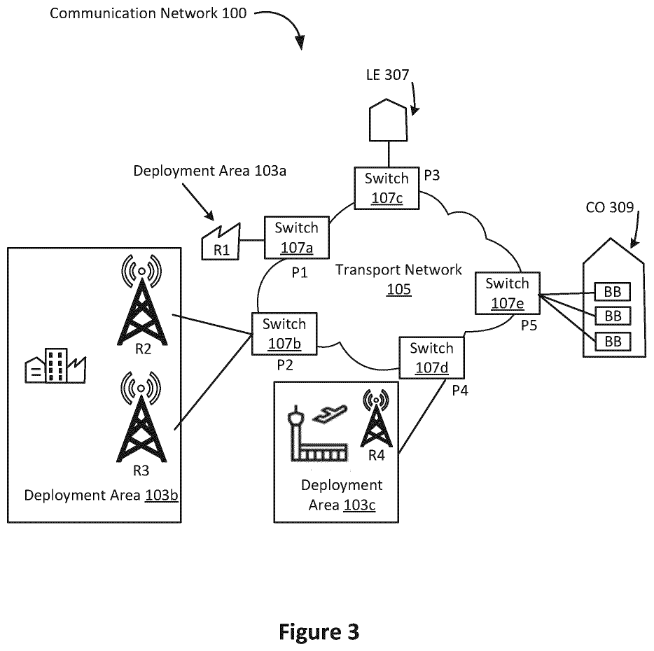

FIG. 3 is a schematic diagram illustrating an example communication network (100) of some embodiments of the present disclosure. Radio sites R1, R2, R3, and R4 are connected to a Central Office (CO) 309 and to a Local Exchange (LE) 307 through a transport network 105. In the example of FIG. 3, border nodes are packet switches 107a-107e. The transport network 105 can be based on different technologies, for example an optical network based on optical switches coupled with the packet switches 107a-107e. For ease of discussion, however, and without limitation, the packet switches 107a-107e in FIG. 3 represent switches in a mobile site and ingress to the transport network 105. Three deployment areas (also referred to herein as “service areas”, “coverage areas”, “geographical areas”, or “local areas” are illustrated): a local indoor factory 103a, an urban geographical area 103b, and a local outdoor area for an airport 103c.

In the communication network 100 of FIG. 3, at the packet switch level 107a-107e, monitoring points P1-P5 corresponding to each packet switch 107a-107e are present. The monitoring points P1-P5 can be dedicated to capturing actual values of parameters related to the traversing traffic. In some embodiments, each active transport tunnel (e.g., VLAN) is metered in terms of a QoS parameter(s) (e.g., PIR, CIR, and/or CBS) and an effective bandwidth. The effective bandwidth (“Eff. BW” or “new bandwidth value”) is a parameter having a value calculated by the AI model as a function of the QoS parameter (e.g., PIR, CIR, CBS), e.g., according to a formula. In some embodiments, the formula may be a formula referenced in “A New Approach for Allocating Buffers and Bandwidth to Heterogeneous, Regulated Traffic in an ATM Node”, A. Elwalid et al., IEEE JOURNAL ON SELECTED AREAS IN COMMUNICATIONS, Vol. 13, No. 6, August 1995), which is hereby incorporated by reference in full:

$$\begin{matrix}Eff \cdot BW = \frac{PIR}{1 + \frac{D}{CBS} \cdot ( PIR - CIR )} & if CIR \leq \frac{CBS}{D} \\ EFF \cdot BW = CIR & if \frac{CBS}{D} \leq CIR \leq PIR\end{matrix}$$

where D is a network node parameter defining the maximum delay the switching node can introduce on the connection due to buffering in case of congestion. The effective bandwidth used is a bandwidth for statistical multiplexing without losses.

In the example embodiment of FIG. 3, four transport tunnels (VLANs 1-4) are active in transport network 105 to connect the four antennas R1-R4 to CO 309 or to LE 307. The following table illustrates example values of QoS parameters PIR, CIR, and CBS, and an effective bandwidth (also referred to as a “new bandwidth value”) at reference time t=0 for each VLAN 1-4:

| Deployment | VLAN | | | | | | Effective |
|---|---|---|---|---|---|---|---|
| Area | ID | Path | Slice | PIR | CIR | CBS | Bandwidth |
| D1 | 1 | R1-P1- | 1 | 10 | 20 | 10 | 40 |
| | | P3-LE | | | | | |
| D2 | 2 | R2-P2- | 2 | 14 | 25 | 9 | 40 |
| | | P5-CO | | | | | |
| D2 | 3 | R3-P2- | 3 | 12 | 24 | 13 | 30 |
| | | P3-LE | | | | | |
| D3 | 4 | R4-P4- | 1 | 7 | 30 | 10 | 50 |
| | | P5-CO | | | | | |

Measurements referred to in the above table are repeated at a defined or specified periodical interval to provide an updated view of the traffic.

Still referring to the example embodiment, values of the metered parameters are sent to a network dynamic module that includes an AI Model (e.g., AI model 205). The network dynamics module includes a processor, memory, and the AI model, as discussed herein, and can perform operations including connection admission control (CAC) and network dynamics (ND).

In some embodiments, a CAC operation is invoked when a connection is to be established to support a service. The CAC operation can establish a connection when enough resources are available by informing the involved nodes that the connection can be activated. On the other hand, if resources are not available, the connection is rejected, and a notification is sent back to the originator or requester of the service. Given the bandwidth value of the E2E slice, an assigned initial bandwidth of each transport tunnel (e.g., VLAN) is decided according to a policy of operator. For example, for service at a high priority and guarantee bandwidth, the assigned initial bandwidth of each transport tunnel initially can be the effective bandwidth of the E2E slice (e.g., overprovisioning), while, in other cases the bandwidth needed by the E2E slice on a geographical area can be equally portioned among the transport tunnels. Thus, the CAC operations can be performed based on such an assigned initial bandwidth. Such assigned initial bandwidth value can be tuned in a runtime phase (also referred to herein as network dynamics) based on traffic measurements that allow estimation of the actual bandwidth value (also referred to herein as a “new bandwidth value”). Network dynamics refers to allocation of resources in the transport network and their subsequent improvement or optimization of performance for an accepted service(s).

In some embodiments, network dynamics (ND) operations are performed. In some embodiments, the ND operations can decide, at runtime, a best routing path based on the transport network status and related traffic trends. Additionally, in some embodiments, ND operations can provide inputs to define an abstraction for the transport resources according to traffic trends.

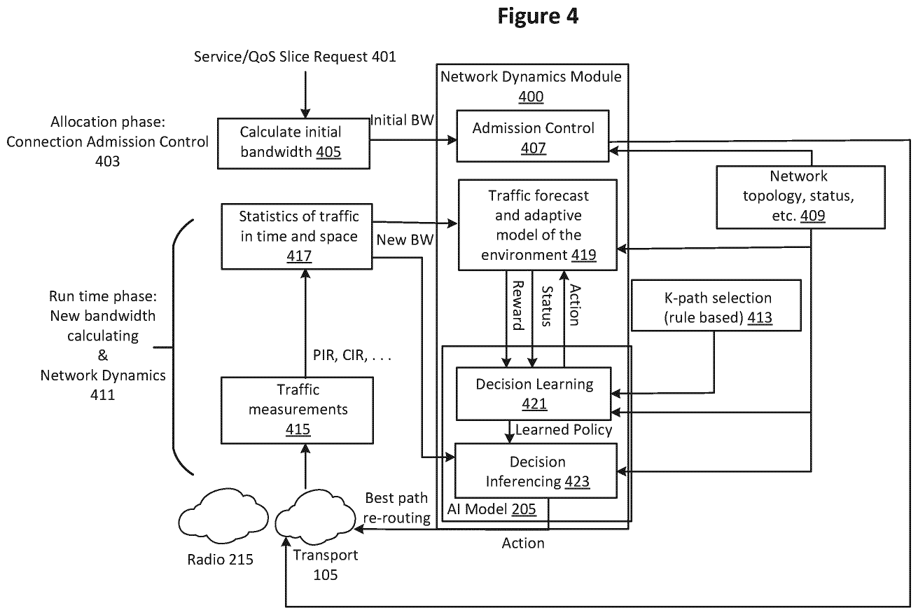

FIG. 4 is a schematic diagram illustrating a communication network including a network dynamics module 400 in accordance with some embodiments of the present disclosure. The network dynamics module 400 can include four sub-systems: admission control module 407, traffic forecast and adaptive model of the environment 419, decision learning module 421, and decision inferencing module 423 which close a loop with the transport network 105, as illustrated in FIG. 4. In some embodiments, decision learning module 421 and decision inferencing module 423 are include in AI model 205.

Referring to the example of FIG. 4, in some embodiments, the network dynamics module 400 receives traffic measurements 415 of traffic parameters of each transport tunnel (e.g., VLAN) in transport border nodes; and corresponding PIR, CIR and CBS parameters are computed. An initial new bandwidth value is determined 417 (e.g., based on the formula discussed above) and is used to summarize the traffic requirements of a single connection. Iterating this computation, a sequence of data for each VLAN is obtained, in relation to a deployment area, yielding a spatial-temporal information. The spatial-temporal information is used by traffic forecast and adaptive model of the environment 419 to predict a future network scenario(s) in terms of required bandwidth. This forecast, together with network topology and a snapshot of the actual network 409, compose a state of the decision learning module 421 deemed to take some action in terms of resource allocation with a goal to balance the load across the transport network 105. A reward used in the learning phase of the decision learning module 421 follows the load balancing principle.

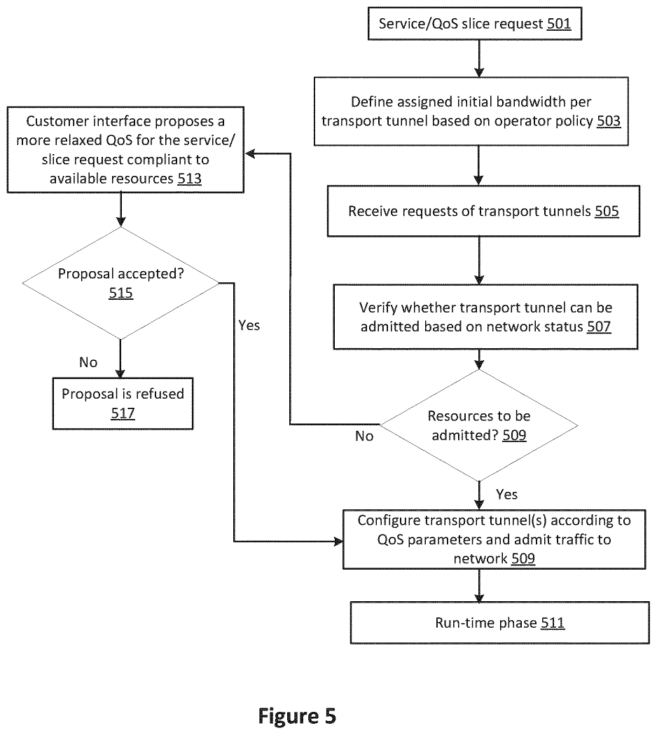

FIG. 5 is a flowchart of operations for an allocation phase in accordance with some embodiments of the present disclosure. Referring to the example of FIGS. 4 and 5, in block 501, a request for service having a QoS parameter(s) is received at node 405. In block 503, an assigned initial bandwidth for each transport tunnel (e.g., VLAN) is assigned on the basis of an operator/requestor policy and is associated to the E2E slice.

In block 505, admission control module 407 receives the requests of a plurality of transport tunnels (e.g., VLANs) associated to the same E2E slice in terms of source(s), destination(s), initial assigned bandwidth, priority, service type, etc.

In block 507, admission control module 407 verifies whether a transport tunnel can be admitted based on a network indicator 409 (e.g., network is down, network is undergoing maintenance, network is active, etc.).

In block 509, admission control module 407 determines whether the resources are to be admitted. If yes, in block 511 during a runtime phase, transport tunnels (e.g., VLANs) are configured according to the QoS parameters, and data traffic is admitted to the transport network 105.

If no, in block 513, a proposal can be made to the service provider/requester/customer that proposes a more relaxed QoS parameter(s) for the service/slice request that is compliant with the available resources. In block 515, the service provider/requester/customer can choose whether to accept the proposed QoS parameter(s). If yes, in block 511 during a runtime phase, transport tunnels (e.g., VLANs) are configured according to the QoS parameters, and data traffic is admitted to the transport network 105. If no, in block 517, the request is refused or rejected.

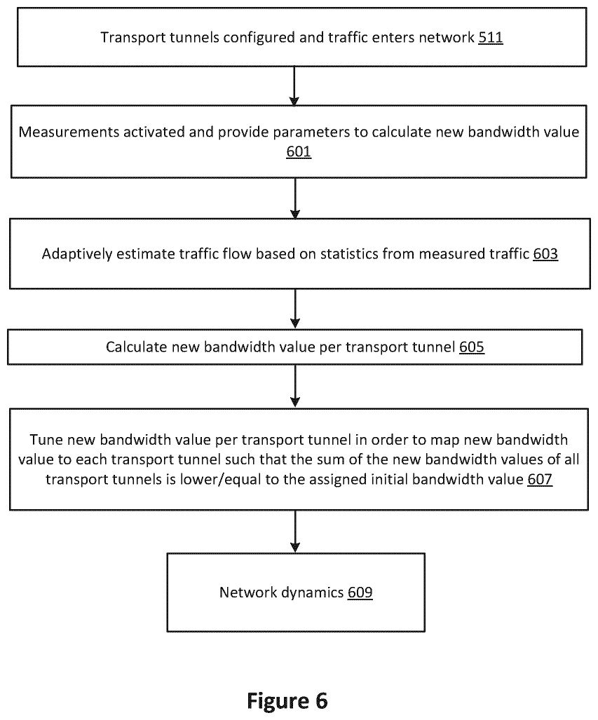

FIG. 6 is a flowchart of operations during a runtime phase for calculating a new bandwidth value and traffic statistics in accordance with some embodiments of the present disclosure. Referring to the example of FIGS. 4, 5, and 6, as discussed, in block 511, transport tunnels of a transport slice are configured and traffic enters the transport network.

In block 601, measurements are activated and provide parameters to calculate the new bandwidth value in time and in space. For example, the measurements are provided for each transport tunnel (such as a VLAN) indicating which transport slice belongs to the E2E slice.

In block 603, based on the measurements from block 601, statistics regarding the traffic are calculated using traffic forecast and adaptive model of the environment 419, as discussed further herein.

In block 605, the new bandwidth value for each traffic tunnel (e.g., VLAN) is calculated.

In block 607, the new bandwidth value is tuned in order to map the tuned new bandwidth value to each transport tunnel (e.g., VLAN) such that the sum of the new bandwidth values of all transport tunnels is lower than or equal to the initial bandwidth value assigned to the E2E slice.

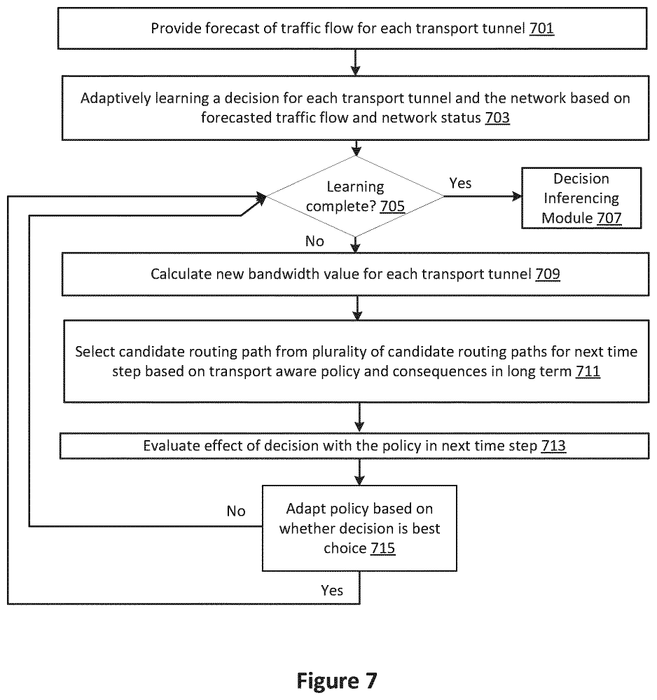

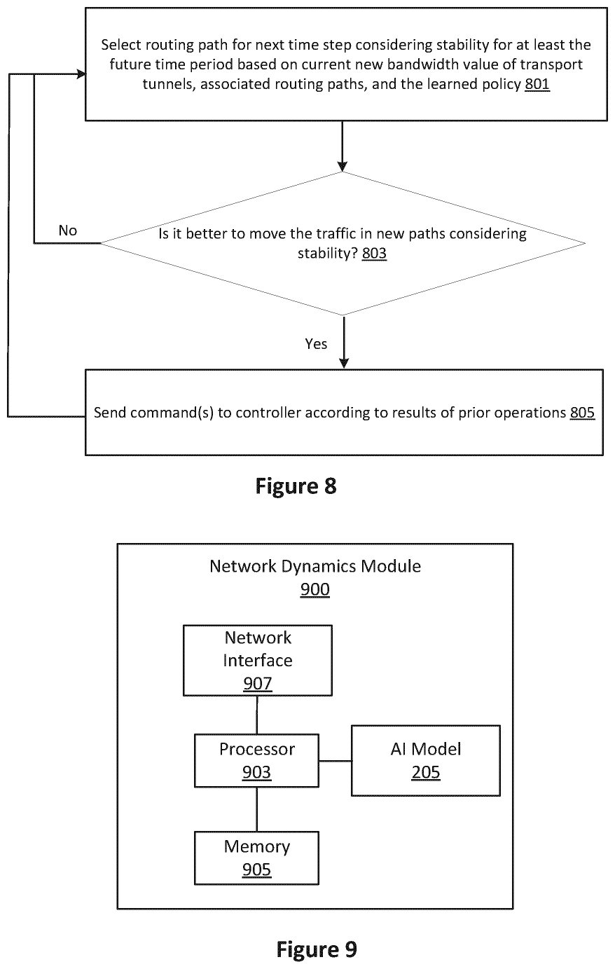

In block 609, network dynamics operations are performed as discussed herein with reference to FIGS. 7 and 8.

FIG. 7 is a flowchart of operations during a runtime phase for a learning workflow for network dynamics in accordance with some embodiments of the present disclosure. Continuing with the example of FIGS. 4, 5, 6, and 7, in block 701, traffic forecast and adaptive model of the environment 419 forecasts a traffic trend(s) for each transport slice associated to each E2E slice.

In block 703, decision learning module 421 learns for each transport tunnel (e.g., VLAN) associated to each E2E slice (in order to consider variations in space) and the whole network on the basis of a snapshot (e.g., a current status) of the network.

In block 705, decision learning module 421 determines whether learning is complete. If yes, in block 707, decision inferencing module 423 performs operations as discussed further with reference to FIG. 8.

If no, in block 709, calculation of the new bandwidth value for each transport tunnel (e.g., VLAN) is performed associated to each E2E slice.

In block 711, a plurality of candidate routing paths received in ingress (e.g., computed by an external path computation element (PCE), etc.) and a snapshot of the network status (e.g., a current status) are considered, and a routing path (e.g., a best routing path) is selected for a next time step based on (i) a transport aware policy (e.g., according to the transport technology, the policy defines load balancing or other techniques), and (ii) stability consequences of the selection for a future time period (e.g., a medium or long term future time period).

In block 713, an effect of the selection determined in accordance with the policy is evaluated in the next time step.

In block 715, decision learning module 421 adapts the policy based on whether the decision is the best choice. If yes, decision learning module 421 determines in block 705 that learning is complete, and operations proceed to block 707.

If no, decision learning module 421 adapts the policy and repeats the operations of blocks 709-715 until learning is complete.

FIG. 8 is a flowchart of operations during a runtime phase for a decision inferencing workflow for network dynamics in accordance with some embodiments of the present disclosure. Referring to the example of FIGS. 4, 5, 6, 7, and 8, in block 801, based on a current new bandwidth value of all transport tunnels, the associated paths, and the learned policy, decision inferencing module 423 selects a routing path for the next time step considering stability of the selection for a future time period (e.g., a long term future time period).

In block 803, decision inferencing module 423 determines whether it is better to move traffic to the selected routing path in light of the stability consideration. If yes, in block 805, decision inferencing module 423 sends a command to another network node (e.g., a transport controller such as a management controller, etc.) according to the results of operations 801 and 803 that resulted on the decision to move the traffic to the selected routing path.

If no, operations 801-803 are repeated.

Traffic measurements and statistics from the traffic measurements are now discussed further. Traffic measurements can include, without limitation, a plurality of packets comprising a plurality of bytes in the traffic flow. Statistics from the traffic measurements can include, without limitation, determining variations in byte characteristics in the packets. From the traffic measurements, a QoS parameter(s) can be determined. For example, a CIR and a CBS can be estimated from traffic measurements relating to variations in the bytes of the measured packets; and a PIR can be estimated from the CIR and CBS. The new bandwidth value can be calculated from the PIR, CIR, and CBS. In some embodiments, traffic flow analyzer 417 includes a metering function that can measure at any time step (e.g., 10 minutes) traffic measurements of each active connection. Traffic measurements are used to determine a QoS parameter(s) (e.g., PIR, CIR, CBS, etc.) and the new bandwidth value is calculated from the QoS parameter(s). In some embodiments, the calculation is performed, e.g., using an underlying algorithm such as discussed in M. Puleri, “Packet network traffic flow effective bandwidth estimation apparatus and method”, patent publication WO 2013/120540 A1 which is hereby incorporated in full by reference.

In some embodiments, the process of traffic flow analyzer 417 can be performed by a switch itself or by an external computing device mirroring traffic on a certain port to the computing device itself.

Because the new bandwidth value can be considered, to a certain extent, as a summary of the bandwidth required or needed, it can be used to represent the spatio-temporal information. Every connection is associated to a coverage area and the repeated measure, thus, defines temporal behavior on a particular area (or in other words, in a particular space).

In some embodiments, a Short-Time Fourier Transformation (STFT), is used on such a signal to reveal some property of the connection profile (e.g., some periodicity) directly as a 2D matrix.

In some embodiments, the new bandwidth value is input to the traffic forecast and adaptive model of the environment 419, which goes in search of relevant trends and makes traffic predictions.

In another embodiment, a statistical analysis is performed to extract a trend and behavior (e.g., a seasonal trend and residual behavior). For example, seasonal behaviors can be statistical periodical behaviors that can be extracted with determined periodicities (e.g. the daily and weekly behaviors), and the trend can represent the non-periodical component through time and the residual is the remaining random component.

Forecasting of traffic trends will now be discussed further. In some embodiments, traffic forecast and adaptive model of the environment 419 can forecast traffic trends and dynamics from traffic measurements and statistics computed during the traffic measurements and statistics operations. This data can be integrated with a snapshot of network status (e.g., a current network status) and with external information related to specific circumstances (e.g., time of the day, planned events, etc.).

In some embodiments, traffic forecast and adaptive model of the environment 419 can leverage on a Bayesian Networks probabilistic model combined with an Approximate Nearest Neighbor search. Traffic forecast and adaptive model of the environment 419 can estimate future traffic trends and, thus, can allow the network to be aware of possible upcoming scenarios and take action(s) to tackle them (e.g., re-routing).

In another embodiment, traffic forecast and adaptive model of the environment 419 can forecast the behavior of traffic combining the statistical models acquired by the traffic flow analyzer 417 and estimate a trend and behavior (e.g., a seasonal trend and residual behavior) in the future. This forecast can be performed for each connection determining its possible behavior with a confidence level for each time step in the future. The confidence level has a value representing a level of certainty ranging from 0%-100% for the forecast.

The AI model will now be discussed further. In some embodiments, a goal of operations of the AI model (e.g., AI model 205) is to take some action on the network in response to certain stimulus. In an example embodiment, the action can be to allocate a new connection request, or to tune the allocated bandwidth of a certain connection according to the actual need.

In some embodiments, the AI model is, without limitation, an adaptive time-varying Markov Decision Process (AMDP) using Q-learning or deep Q-learning, etc. to determine a policy (e.g., an optimal policy). In some embodiments, identification of a sequence of actions to be deployed in the transport network (e.g., an optimal sequence) is taken by an AMDP. During the learning phase, decision learning module 421 tries to find an optimal policy to balance the traffic in time and space in the network finding an optimal allocation strategy of routing paths to each connection over time. The state includes the connections' new bandwidth values, and their corresponding paths. A reward function considers the goodness of selecting certain routing paths for the connections over time allowing the optimization of the policy.

In some embodiments, the learning phase of decision learning module 421 is repeated periodically, and the policy updated accordingly. A period for the repeating is determined by a confidence level for the forecast. The policy determined at one learning phase is used by the decision inference module 423 until the new policy is available. In some embodiments, the decision inference module 423 is expected to respond properly to the changes in traffic according to the forecast model used during the training.

In some embodiments, a state of the decision inference module 423 is represented by the actual bandwidth measurements taken by measurements and statistics 417 together with the set of routing paths set for the connections and overall network information (e.g., as link property, actual load, and topology).

In some embodiments, an action(s) defined in the AI model (e.g., AI model 205) is to provide the best routing path (if any exist) to accommodate a certain connection together with defining the appropriate resource level to be allocated. The AI model is trained following the load balancing criterion, meaning that a reward value based on this principle is associated to any action and the AI model tries to maximize the reward.

Additionally, in some embodiments, a filter on the set of routing paths is applied not only to maintain feasible paths but also to suggest the best candidate routing paths. A goal of this operation may be to reduce training complexity and computational requirements.

In some embodiments, when a new connection is admitted in the system and has no historical data, a conservative policy can be set for it and the overall (e.g., optimal) policy is recomputed. The new policy can replace the one already in use to consider the new connection.

Non-exhaustive examples of applications of the system, network dynamics module, and method of the present disclosure will now be discussed further.

In a first example in accordance with some embodiments of the present disclosure, instantiation of a new connectivity is provided. A decision is made as to whether and how to accommodate a new request for connection. While some approaches look just at the local information at the ingress point, the method of the present disclosure can have a wider vision that can also consider the status of the entire network (in terms of link load, type, etc.) and a traffic forecast information to predict situations (e.g., critical situations).

In a second example in accordance with some embodiments of the present disclosure, network resource optimization may be provided. In accordance with some embodiments, use of network resources may be improved or optimized. In some embodiments, the allocated bandwidth is adapted or tuned in response to traffic trends computed by the modules of the network dynamics module. For example, connections are often overprovisioned, which can waste a lot of resources. In some embodiments, the network dynamics module and method of the present disclosure can dynamically tune the allocated bandwidth, which may result in alleviating overprovisioning and thus provide value. In some embodiments, the method can partition the effective bandwidth (e.g., the QoS parameter(s)) associated to the E2E slice among the transport tunnels (e.g., VLANs) corresponding to the behavior in time and in space of the traffic in the transport tunnels belonging to the same E2E slice.

In another example in accordance with some embodiments of the present disclosure, traffic improvements or optimization may be provided. Knowledge of the network status, together with the traffic trends, can allow load balancing and traffic improvement or optimization. For example, this may be intrinsic in the AI model that is optimized in this sense based on realizing a traffic engineering process (e.g., a decision to route a connection in a certain routing path instead of other routing paths).

In another example in accordance with some embodiments of the present disclosure, congestion prevention and mitigation may be provided. Traffic forecast and network knowledge are input for a decision to decide if a connection can be accommodated and on which routing path. Thus, resources may be reallocated or a connection(s) may be discarded before congestion happens.

In yet another example in accordance with some embodiments of the present disclosure, network failure or maintenance may be addressed. For example, in case of a network fault or planned maintenance, the availability of the network status can allow for a fast and automatic re-routing of involved connections and, thus, may reduce the downtime.

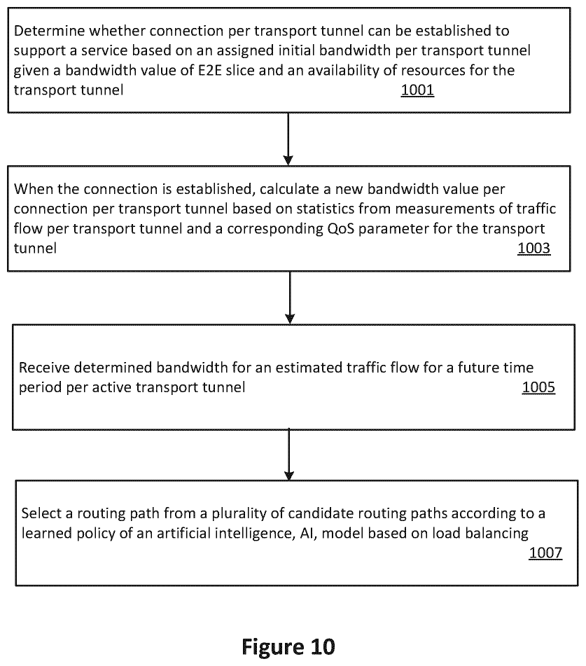

FIG. 9 is a block diagram illustrating elements of a network dynamics module 900 for a communication network (e.g., a communication network comprising a transport network as discussed further herein) according to embodiments of the present disclosure. A network dynamics module node refers to equipment capable, configured, arranged, having modules configured to and/or operable to communicate directly or indirectly with a with other network modules, nodes or equipment, in or for a communication network. Examples of a network dynamic module include, but are not limited to, an orchestrator node, a transport controller node, a switch node inside the communication network, a single module serving an entire transport network, etc.

Network dynamics module 500 may be provided, for example, as discussed herein with respect to network node 400 of FIG. 4, a cloud-implemented network dynamics module (e.g., a server) or located in the cloud or an edge-implemented network dynamics module (e.g., a server), a virtual machine in a cloud deployment, or the network dynamics module can be distributed over several virtual machines, containers, or function as a service (FaaS) procedures, all of which should be considered interchangeable in the examples and embodiments described herein and be within the intended scope of this disclosure, unless otherwise noted. All components/modules in FIG. 4 can be distributed in the communication network, a cloud environment, etc.

For ease of discussion, a network dynamics module will now be described with reference to FIG. 9. As shown, the network dynamics module may include transceiver circuitry (not illustrated) including a transmitter and a receiver configured to provide uplink and downlink radio communications with mobile terminals (also referred to herein as UEs). The network dynamics module may include network interface circuitry 907 (also referred to as a network interface) configured to provide communications with other modules or nodes (e.g., with other components of FIG. 4) in or for the communication network. The network dynamics module may also include processing circuitry 903 (also referred to as a processor) and an AI model 205 coupled to the network interface 907 and/or transceiver circuitry, and memory circuitry 905 (also referred to as memory) coupled to the processing circuitry 903 and the AI model 205. The memory circuitry 905 and the AI model 205 may include computer readable program code that when executed by the processing circuitry 903 and/or the AI model 205 causes the processing circuitry and/or the AI model 205 to perform operations according to embodiments disclosed herein. According to other embodiments, processing circuitry 903 and/or AI model 205 may be defined to include memory so that a separate memory circuitry is not required.

As discussed herein, operations of the network dynamics module may be performed by processing circuitry 903, the AI model 205, network interface 907, and/or transceiver. For example, processing circuitry 903 and/or AI model 205 may control transceiver to transmit downlink communications through transceiver over a radio interface to one or more mobile terminals UEs and/or to receive uplink communications through transceiver from one or more communication devices over a radio interface. Similarly, processing circuitry 903 and/or AI model 205 may control network interface 907 to transmit communications through network interface 907 to one or more other modules, components, or network nodes and/or to receive communications through network interface 907 from one or more other modules, components, network nodes, communication devices, etc. Moreover, modules may be stored in memory 905 and/or in AI model 205, and these modules may provide instructions so that when instructions of a module are executed by processing circuitry 903 and/or AI model 205, processing circuitry 903 and/or AI model 205 performs respective operations (e.g., operations discussed herein with respect to example embodiments relating to network dynamic modules). According to some embodiments, network dynamic module 900 and/or an element(s)/function(s) thereof may be embodied as a virtual modules, virtual node/nodes, and/or a virtual machine/machines.

According to some other embodiments, a network dynamic module may be implemented as a module without a transceiver. In such embodiments, transmission to another module, a component, a communication device, a network node, etc. may be initiated by the network dynamics module 900 so that transmission to the module, the component, the communication device, network node, etc. is provided through a network device including a transceiver (e.g., through a switch, a controller, etc.).

Embodiments of the network dynamics module may include additional components beyond those shown in FIG. 9 for providing certain aspects of the network dynamic module's functionality, including any of the functionality described herein and/or any functionality necessary to support the subject matter described herein. For example, the network dynamics module 900 may include user interface equipment to allow input of information into the network dynamics module 900 and to allow output of information from the network dynamics module 900. This may allow a user to perform diagnostic, maintenance, repair, and other administrative functions for the network dynamics module 900.

Although network dynamics module 900 is illustrated in the example block diagram of FIG. 9, the block diagram may represent a device that includes the illustrated combination of hardware components, other embodiments may comprise network dynamics modules with different combinations of components. It is to be understood that a network dynamics module comprises any suitable combination of hardware and/or software needed to perform the tasks, features, functions, and methods disclosed herein. Moreover, while the components of a network dynamics module are depicted as single boxes located within a larger box, or nested within multiple boxes, in practice, each device may comprise multiple different physical components that make up a single illustrated component (e.g., a memory may comprise multiple separate hard drives as well as multiple RAM modules).

Example communication networks may include and/or interface with any type of communication, telecommunication, data, cellular, radio network, and/or other similar type of system including, but not limited to, a 4G, 5G and/or 6G network and a transport network. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication network may include any number of wired or wireless networks, network nodes, communication devices, and/or any other components or systems that may facilitate or participate in the communication of data and/or signals whether via wired or wireless connections.

As a whole, the communication network enables connectivity between network dynamics modules, switches, computing devices, communication devices, network nodes, hosts, data repositories, etc. In that sense, the communication network may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network includes a cellular network that implements 3GPP standardized features. Accordingly, the communications network may support network slicing to provide different logical networks to different devices that are connected to the communication network. For example, the communications network may provide Ultra Reliable Low Latency Communication (URLLC) services to some communication devices, while providing Enhanced Mobile Broadband (eMBB) services to other communication devices, and/or Massive Machine Type Communication (mMTC)/Massive IoT services to yet further communication devices.

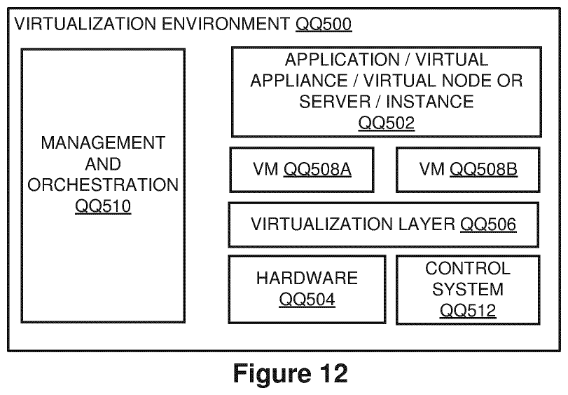

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network dynamics module, network node, communication device, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

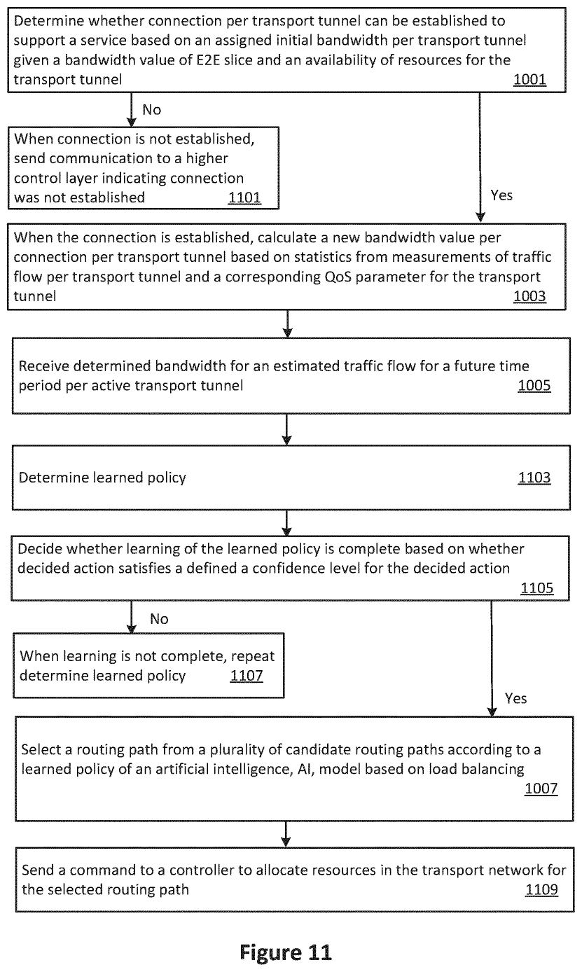

Operations of a network dynamics module node (e.g., network dynamics module 400) (implemented using the structure of FIG. 9) will now be discussed with reference to the flow charts of FIGS. 10 and 11 according to some embodiments of the present disclosure. In the description that follows, while the network dynamics module may be any of the network dynamics module 400, a virtual machine, a distributed over more than one virtual machine, the network dynamics module 900 shall be used to describe the functionality of the operations of the network dynamics module. For example, modules may be stored in memory 905 and/or AI model 205 of FIG. 9, and these modules may provide instructions so that when the instructions of a module are executed by respective network dynamics module processing circuitry 903, processing circuitry 903 performs respective operations of the flow chart.

Referring to FIG. 11, a method performed by a network dynamics module (400, 900) for a communication network (100) comprising a transport network (103) is provided. The transport network includes at least one transport slice comprising a plurality of transport tunnels for a service on a service area defined by an end-to-end, E2E, slice, and a quality of service, QoS, parameter per transport tunnel. The method includes determining (1001) whether a connection per transport tunnel from the plurality of transport tunnels can be established to support the service based on an assigned initial bandwidth per transport tunnel given a bandwidth value of the E2E slice and an availability of resources for the transport tunnel. The assigned initial bandwidth value is determined according to a policy of an operator or a requester of the service. The method further includes, when the connection is established, calculating (1003) a new bandwidth value per connection per transport tunnel based on statistics from measurements of traffic flow per transport tunnel and a corresponding QoS parameter for the transport tunnel. The method further includes receiving (1005) a determined bandwidth for an estimated traffic flow for a future time period per active transport tunnel in the plurality of transport tunnels. The determined bandwidth calculated from measurements at a defined periodicity of traffic and the QoS parameter per active transport tunnel. The method further includes selecting (1007) a routing path from a plurality of candidate routing paths according to a learned policy of an AI model that selects the routing path based on load balancing for the future time period in view of the bandwidth of the estimated traffic flow, the new bandwidth values, and the bandwidth value of the E2E slice.

In some embodiments, the calculating (1003) the new bandwidth value comprises: accessing, for a time period, the measurements of traffic flow per transport tunnel and the corresponding QoS parameter for the transport tunnel; calculating the statistics that reflect variations of the measured traffic flow and the corresponding QoS parameter over the time period and over at least one deployment area in the communication network; calculating the new bandwidth value from the statistics; and tuning the new bandwidth value per transport tunnel such that the sum of the new bandwidth value per traffic tunnel for the plurality of transport tunnels is less than or equal to the bandwidth value of the E2E slice for the future time period.

In some embodiments, the tuning of the new bandwidth value per transport tunnel is performed dynamically based on changing traffic flows as the service changes in at least one of time and the service area.

Referring now to FIG. 11, in some embodiments, the method further includes determining (1103) the learned policy. The determining (1103) comprises receiving the estimated traffic flow for the future time period per transport tunnel in the plurality of transport tunnels. The determining (1103) further comprises deciding an action to take in the transport network in response to a state where the action maximizes a reward value. The state comprises the bandwidth for the estimated traffic flow, a topology of the transport network, and a snapshot of the transport network indication about external events or special events. The action comprises the identification of the candidate routing path with an associated reward value. The determining (1103) further comprises evaluating the effect of the action with the learned policy in a next time step.

In some embodiments, the method further comprises deciding (1105) whether learning of the learned policy is complete based on whether the decided action satisfies a defined a confidence level for the decided action; and when the learning is not complete, repeating (1107) the deciding action and the evaluating until the learning is completed based on the defined confidence level.

Referring to FIGS. 10 and 11, in some embodiments, the selecting (1007) a routing path from the plurality of candidate routing paths according to the learned policy comprises selecting a candidate routing path from the plurality of candidate routing paths for the next time step based on (i) the new bandwidth values per transport tunnel, their associated candidate routing paths, and the learned policy, and (ii) a stability of the selected candidate routing path on the transport network for at least the future time period. The selecting (1007) further comprises deciding whether to move traffic to the selected candidate routing path based on consideration of the effect of the selected candidate routing path on the transport network for at least the future time period. The selecting (1007) further comprises, when the deciding is to not move traffic to the selected candidate routing path, selecting another candidate routing path for the next time step based on (i) updated new bandwidth values per transport tunnel, their associated candidate routing paths, and the learned policy, and (ii) a stability of the selected another candidate routing path on the transport network for at least the future time period, and repeating the deciding whether to move traffic for the selected another candidate path until the routing path is selected.

Referring again to FIG. 11, in some embodiments, the method further includes sending (1109) a command to a controller to allocate resources in the transport network for the selected routing path.

In some embodiments, the QoS parameter comprises at least one of a peak information rate, PIR, a committed information rate, CIR, and a committed burst size, CBS

Referring to FIGS. 10 and 11, in some embodiments, the selecting (1007) a routing path from a plurality of candidate routing paths comprises at least one of a re-routing to another routing path or a preemption of the selected routing path to increase an amount of traffic the communication network can support.

In some embodiments, the estimated traffic flow is estimated based on at least one of a statistical analysis and a trend analysis that reveals a periodic or a non-periodic trend of traffic flow measured at a periodicity per active transport tunnel in the plurality of transport tunnels.

Referring to FIG. 11, in some embodiments, the method further comprises, when the connection is not established, sending (1101) a communication to a higher control layer, such as a service specific control layer, indicating the connection was not established.

In some embodiments, the AI model comprises a Q-learning model.

In some embodiments, the network dynamics module comprises one of an orchestrator node and a transport controller node.

Various operations from the flow chart of FIG. 11 may be optional with respect to some embodiments of a method performed by a network dynamics module. For example, operations of blocks 1101-1109 of FIG. 11 may be optional.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a network dynamics module for a communication network comprising a transport network, the transport network including at least one transport slice comprising a plurality of transport tunnels for a service on a service area defined by an end-to-end, E2E, slice, and a quality of service, QoS, parameter per transport tunnel, the method comprising:
determining whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculating a new bandwidth value per connection per transport tunnel based on statistics from measurements of traffic flow per transport tunnel and a corresponding QoS parameter for the transport tunnel;
receiving a determined bandwidth for an estimated traffic flow for a future time period per active transport tunnel in the plurality of transport tunnels, the determined bandwidth calculated from measurements at a defined periodicity of traffic and the QoS parameter per active transport tunnel; and
selecting a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice.

2. The method of claim 1, wherein the calculating the new bandwidth value comprises:
accessing, for a time period, the measurements of traffic flow per transport tunnel and the corresponding QoS parameter for the transport tunnel;
Filed: Nov. 5, 2021 calculating the statistics that reflect variations of the measured traffic flow and the corresponding QoS parameter over the time period and over at least one deployment area in the communication network;
calculating the new bandwidth value from the statistics; and
tuning the new bandwidth value per transport tunnel such that the sum of the new bandwidth value per traffic tunnel for the plurality of transport tunnels is less than or equal to the bandwidth value of the E2E slice for the future time period.

3. The method of claim 2, wherein the tuning of the new bandwidth value per transport tunnel is performed dynamically based on changing traffic flows as the service changes in at least one of time and the service area.

4. The method of claim 1, further comprising:
determining the learned policy, wherein the determining comprises receiving the estimated traffic flow for the future time period per transport tunnel in the plurality of transport tunnels;
deciding an action to take in the transport network in response to a state where the action maximizes a reward value, wherein the state comprises the bandwidth for the estimated traffic flow, a topology of the transport network, and a snapshot of the transport network indication about external events or special events, and the action comprises the identification of the candidate routing path with an associated reward value; and
evaluating the effect of the action with the learned policy in a next time step.

5. The method of claim 4, further comprising:
deciding whether learning of the learned policy is complete based on whether the decided action satisfies a defined a confidence level for the decided action; and
when the learning is not complete, repeating the deciding action and the evaluating until the learning is completed based on the defined confidence level.

6. The method of claim 1 wherein the selecting a routing path from the plurality of candidate routing paths according to the learned policy comprises:
selecting a candidate routing path from the plurality of candidate routing paths for the next time step based on the new bandwidth values per transport tunnel, their associated candidate routing paths, and the learned policy, and a stability of the selected candidate routing path on the transport network for at least the future time period;
deciding whether to move traffic to the selected candidate routing path based on consideration of the effect of the selected candidate routing path on the transport network for at least the future time period; and
when the deciding is to not move traffic to the selected candidate routing path, selecting another candidate routing path for the next time step based on updated new bandwidth values per transport tunnel, their associated candidate routing paths, and the learned policy, and a stability of the selected another candidate routing path on the transport network for at least the future time period, and repeating the deciding whether to move traffic for the selected another candidate path until the routing path is selected.

7. The method of claim 1, further comprising:
sending a command to a controller to allocate resources in the transport network for the selected routing path.

8. The method of claim 1, wherein the QoS parameter comprises at least one of a peak information rate, PIR, a committed information rate, CIR, and a committed burst size, CBS.

9. The method of claim 1, wherein the selecting a routing path from a plurality of candidate routing paths comprises at least one of a re-routing to another routing path or a preemption of the selected routing path to increase an amount of traffic the communication network can support.

10. The method of claim 1, wherein the estimated traffic flow is estimated based on at least one of a statistical analysis and a trend analysis that reveals a periodic or a non-periodic trend of traffic flow measured at a periodicity per active transport tunnel in the plurality of transport tunnels.

11. The method of claim 1, further comprising:
when the connection is not established, sending a communication to a higher control layer indicating the connection was not established.

12. The method of claim 1, wherein the AI model comprises a Q-learning model.

13. The method of claim 1, wherein the network dynamics module comprises one of an orchestrator node and a transport controller node.

14. A network dynamics module for a communication network comprising a transport network including at least one transport slice comprising a plurality of transport tunnels for a service on a service area defined by an end-to-end, E2E, slice, and a quality of service, QoS, parameter per transport tunnel, the network dynamics module comprising:
at least one processor;
at least one memory connected to the at least one processor and storing program code that is executed by the at least one processor to perform operations comprising:
determine whether a connection per transport tunnel from the plurality of transport tunnels can be established to support the service based on an assigned initial bandwidth per transport tunnel given the bandwidth value of the E2E slice and an availability of resources for the transport tunnel, the assigned initial bandwidth value determined according to a policy of an operator or a requester of the service;
when the connection is established, calculate a new bandwidth value per connection per transport tunnel based on statistics from measurements of traffic flow per transport tunnel and a corresponding QoS parameter for the transport tunnel;
receive a determined bandwidth for an estimated traffic flow for a future time period per active transport tunnel in the plurality of transport tunnels, the determined bandwidth calculated from measurements at a defined periodicity of traffic and the QoS parameter per active transport tunnel; and
select a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice.

15. The network dynamics module of claim 14, wherein the at least one memory connected to the at least one processor and storing program code that is executed by the at least one processor to perform operations of:
determining whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculating a new bandwidth value per connection per transport tunnel based on statistics from measurements of traffic flow per transport tunnel and a corresponding QoS parameter for the transport tunnel;
receiving a determined bandwidth for an estimated traffic flow for a future time period per active transport tunnel in the plurality of transport tunnels, the determined bandwidth calculated from measurements at a defined periodicity of traffic and the QoS parameter per active transport tunnel;
selecting a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice; and
sending a command to a controller to allocate resources in the transport network for the selected routing path.

16. A network dynamics module for a communication network comprising a transport network including at least one transport slice comprising a plurality of transport tunnels for a service on a service area defined by an end-to-end, E2E, slice, and a quality of service, QoS, parameter per transport tunnel, the network dynamics module adapted to perform operations comprising:
determine whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculate a new bandwidth value per connection per transport tunnel based on statistics from measurements of traffic flow per transport tunnel and a corresponding QoS parameter for the transport tunnel;
receive a determined bandwidth for an estimated traffic flow for a future time period per active transport tunnel in the plurality of transport tunnels, the determined bandwidth calculated from measurements at a defined periodicity of traffic and the QoS parameter per active transport tunnel; and
select a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice.

17. The network dynamics module of claim 16 adapted to perform operations of:
determining whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculating a new bandwidth value per connection per transport tunnel based on statistics from measurements of traffic flow per transport tunnel and a corresponding QoS parameter for the transport tunnel;
receiving a determined bandwidth for an estimated traffic flow for a future time period per active transport tunnel in the plurality of transport tunnels, the determined bandwidth calculated from measurements at a defined periodicity of traffic and the QoS parameter per active transport tunnel;
selecting a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice; and
sending a command to a controller to allocate resources in the transport network for the selected routing path.

18. A computer program comprising program code to be executed by processing circuitry of a network dynamics module for a communication network comprising a transport network including at least one transport slice comprising a plurality of transport tunnels for a service on a service area defined by an end-to-end, E2E, slice, and a quality of service, QoS, parameter per transport tunnel, whereby execution of the program code causes the network dynamics module to perform operations comprising:
determine whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculate a new bandwidth value per connection per transport tunnel based on statistics from measurements of traffic flow per transport tunnel and a corresponding QoS parameter for the transport tunnel;
receive a determined bandwidth for an estimated traffic flow for a future time period per active transport tunnel in the plurality of transport tunnels, the determined bandwidth calculated from measurements at a defined periodicity of traffic and the QoS parameter per active transport tunnel; and
select a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice.

19. The computer program of claim 18, whereby execution of the program code causes the network dynamics module to perform operations of:
determining whether a connection per transport tunnel from the plurality of transport tunnels can be established to support the service based on an assigned initial bandwidth per transport tunnel given a bandwidth value of the E2E slice and an availability of resources for the transport tunnel, the assigned initial bandwidth value determined according to a policy of an operator or a requester of the service;
when the connection is established, calculating a new bandwidth value per connection per transport tunnel based on statistics from measurements of traffic flow per transport tunnel and a corresponding QoS parameter for the transport tunnel;
receiving a determined bandwidth for an estimated traffic flow for a future time period per active transport tunnel in the plurality of transport tunnels, the determined bandwidth calculated from measurements at a defined periodicity of traffic and the QoS parameter per active transport tunnel;
selecting a routing path from a plurality of candidate routing paths according to a learned policy of an artificial intelligence, AI, model that selects the routing path based on load balancing for the future time period in view of the bandwidth of the estimated traffic flow, the new bandwidth values, and the bandwidth value of the E2E slice; and
sending a command to a controller to allocate resources in the transport network for the selected routing path.

20.-21. (canceled)
